(19) United States
(12) Patent Application Publication
(10) Pub. No.: US 2026/0012070 A1
(43) Pub. Date: Jan. 8, 2026

(54) STEPPER MOTOR

(71) Applicant: AAC Microtech (Changzhou) Co., Ltd., Changzhou City (CN)

(72) Inventors: Lubin Mao, Changzhou (CN); Wei Song, Changzhou (CN); Tong Zhang, Changzhou (CN)

(21) Appl. No.: 18/986,751

(22) Filed: Dec. 19, 2024

Related U.S. Application Data
(63) Continuation of application No. PCT/CN2024/103056, filed on Jul. 2, 2024.

(51) Int. Cl. H02K 37/14

(52) U.S. Cl. CPC H02K 37/14

(57) ABSTRACT

The present disclosure relates to the technical field of motors and, in particular, to a stepper motor. The stepping motor of the embodiments of the present disclosure includes a rotor assembly and a stator assembly. The stator assembly includes a fixation claw pole, a coil, and a housing. The housing includes a plurality of housing walls sequentially connected in a circumferential direction of the coil. The plurality of housing walls include at least one first housing wall. Each first housing wall has a planar outer wall and is formed with a hollowed out portion configured to avoid the coil.

### CROSS REFERENCE TO RELATED APPLICATIONS

The present application is a continuation of PCT Patent Application No. PCT/CN2024/103056, filed Jul. 2, 2024, which is incorporated by reference herein in its entirety.

### TECHNICAL FIELD

The present disclosure relates to the technical field of motors and, in particular, to a stepper motor.

### BACKGROUND

In the existing art, a housing of a stepper motor generally has a circular cross-section, and when the stepper motor is assembled into, for example, an electronic equipment, the size in both width and thickness of the assembly space to be provided for the stepper motor is limited by a diameter of the housing diameter, which is not conducive to product miniaturization.

Therefore, a more miniaturized stepper motor is desired to solve the above technical problems.

### SUMMARY

The present disclosure provides a stepper motor to solve the technical problem of not being conducive to product miniaturization.

To achieve the above objective, the present disclosure provides a stepper motor. The stepper motor includes a rotor assembly and a stator assembly. The rotor assembly includes a rotary shaft, and a steel magnet sleeved to an outer side of the rotary shaft. The stator assembly is sleeved to an outer side of the rotor assembly and includes a fixation claw pole disposed around an outer periphery of the rotor assembly, a coil sleeved to an outer side of the fixation claw pole, and a housing sleeved to the coil. The housing includes a plurality of housing walls sequentially connected in a circumferential direction of the coil. The plurality of housing walls include at least one first housing wall. Each respective first housing wall of the at least one first housing wall has a planar outer wall and is formed with a hollowed out portion configured to avoid the coil, and a portion of the coil is received in the hollowed out portion.

Compared with the existing art, in the stepper motor of the present disclosure, the stepper motor includes a rotor assembly and a stator assembly; the rotor assembly includes a rotary shaft, and a steel magnet sleeved to an outer side of the rotary shaft, the stator assembly is sleeved to an outer side of the rotor assembly and includes a fixation claw pole disposed around an outer periphery of the rotor assembly, a coil sleeved to an outer side of the fixation claw pole, and a housing sleeved to the coil; the housing includes a plurality of housing walls sequentially connected in a circumferential direction of the coil; and the plurality of housing walls include at least one first housing wall, each respective first housing wall of the at least one first housing wall has a planar outer wall and is formed with a hollowed out portion configured to avoid the coil, and a portion of the coil is received in the hollowed out portion. In this manner, the plurality of housing walls are provided to include at least one first housing wall so that since the first housing wall is formed with a hollowed out portion to avoid the coil and a portion of the coil is received in the hollowed out portion, the size of the stepper motor in a direction perpendicular to the outer wall of the first housing wall may not include a thickness of the first housing wall, and thus the size of the stepper motor in the direction perpendicular to the outer wall of the first housing wall is reduced, which is conducive to realizing the miniaturization of the stepper motor. In addition, since the outer wall of the first housing wall is planar, when the stepper motor is assembled, the planar side is easy to mate with other parts, which is conducive to reducing the assembling difficulty of the stepper motor.

### BRIEF DESCRIPTION OF THE DRAWINGS

FIG. 1 is a perspective view of a stepper motor according to an embodiment of the present disclosure.

FIG. 2 is a front view of the stepper motor shown in FIG. 1.

FIG. 3 is a sectional view of the stepper motor shown in FIG. 2 taken along line A-A.

FIG. 4 is a schematic structure view of a stator assembly in the stepper motor shown in FIG. 1.

FIG. 5 is an assembly view of a coil and a housing in the stepper motor shown in FIG. 1.

FIG. 6 is an exploded view of the stepper motor shown in FIG. 1.

FIG. 7 is a sectional view of the stepper motor shown in FIG. 2 taken along line B-B.

FIG. 8 is a sectional view of part of the structure of the stepper motor shown in FIG. 6.

FIG. 9 is a schematic structure view of a fixation claw pole in the stepper motor shown in FIG. 1.

FIG. 10 is a perspective view of a stepper motor according to an embodiment of the present disclosure.

FIG. 11 is a perspective view of the stepper motor shown in FIG. 10 from another viewing angle.

FIG. 12 is a schematic structure view of a stator assembly in the stepper motor shown in FIG. 10.

FIG. 13 is an exploded view of a housing and a coil in the stepper motor shown in FIG. 10.

FIG. 14 is an assembly view of the housing and the coil in the stepper motor shown in FIG. 10.

FIG. 15 is a perspective view of a stepper motor according to an embodiment of the present disclosure.

FIG. 16 is a schematic structure view of a stator assembly in the stepper motor shown in FIG. 15.

FIG. 17 is an exploded view of a housing and a coil in the stepper motor shown in FIG. 15.

FIG. 18 is an assembly view of the housing and the coil in the stepper motor shown in FIG. 15.

FIG. 19 is a perspective view of a stepper motor according to an embodiment of the present disclosure.

FIG. 20 is a schematic structure view of a stator assembly in the stepper motor shown in FIG. 19.

FIG. 21 is an exploded view of a housing and a coil in the stepper motor shown in FIG. 19.

FIG. 22 is an assembly view of the housing and the coil in the stepper motor shown in FIG. 19.

FIG. 23 is a perspective view of a stepper motor according to an embodiment of the present disclosure.

FIG. 24 is a schematic structure view of a stator assembly in the stepper motor shown in FIG. 23.

FIG. 25 is an exploded view of the stator assembly in the stepper motor shown in FIG. 23.

FIG. 26 an assembly view of a fixation claw pole and a support foot assembly in the stepper motor shown in FIG. 23.

### DETAILED DESCRIPTION OF THE EMBODIMENTS

The present disclosure is further described hereinafter in conjunction with the accompanying drawings and embodiments.

It should be noted that terms such as “first,” “second,” and “third” in the description and claims of the present disclosure and in the accompanying drawings are used to distinguish between different objects and are not intended to describe a particular order. In addition, the term “comprise” or “include,” and any variations thereof, is intended to cover non-exclusive inclusion. For example, a process, method, system, product, or apparatus including a series of steps or units is not limited to the listed steps or units, but may further include steps or units that are not listed, or may further include other steps or units that are inherent to the process, method, product, or apparatus.

All directional indications in the embodiments of the present disclosure (such as up, down, left, right, front, back, inside, outside, top, bottom, and the like) are used only to explain relative positional relationships between components in a particular attitude (as shown in the accompanying drawings), and so on, and if that particular attitude is changed, the directional indications are changed accordingly. When an element is the to be “fixed to” or “disposed on” another element, the element may be directly on the another element or there may be an intermediate element. When an element is the to be “connected” to another element, the element may be directly connected to the another element or there may be an intermediate element.

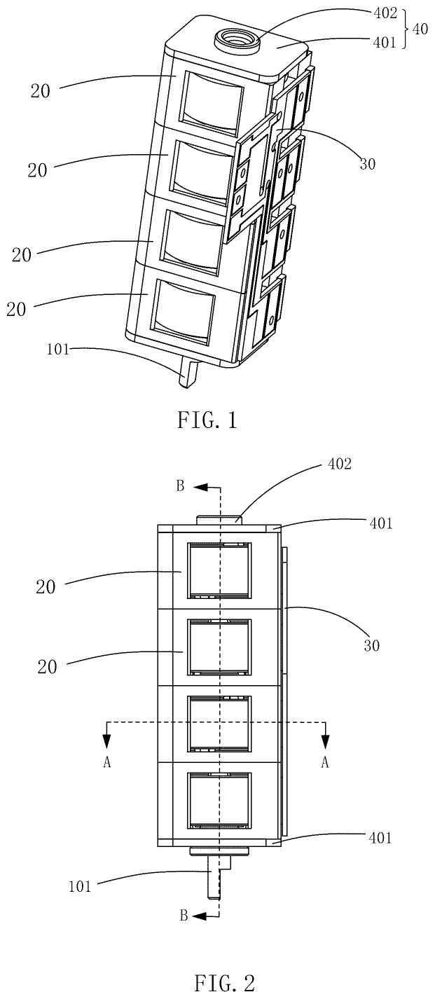

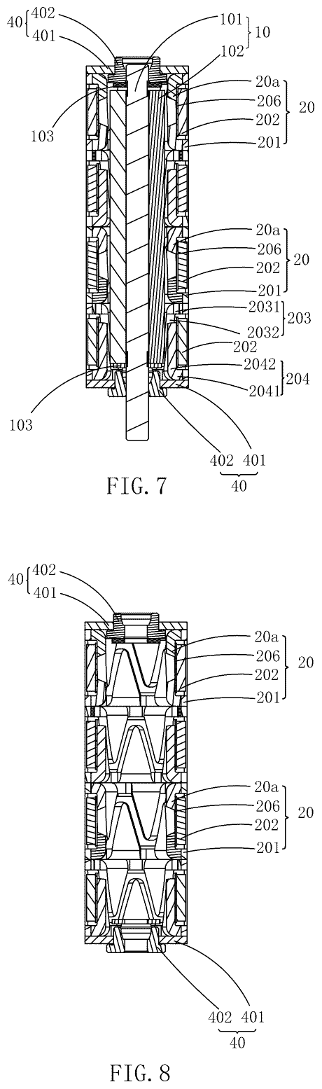

An embodiment of the present disclosure provides a stepper motor. As shown with reference to FIGS. 1 to 9, the stepper motor includes a rotor assembly 10 and one or more stator assemblies 20.

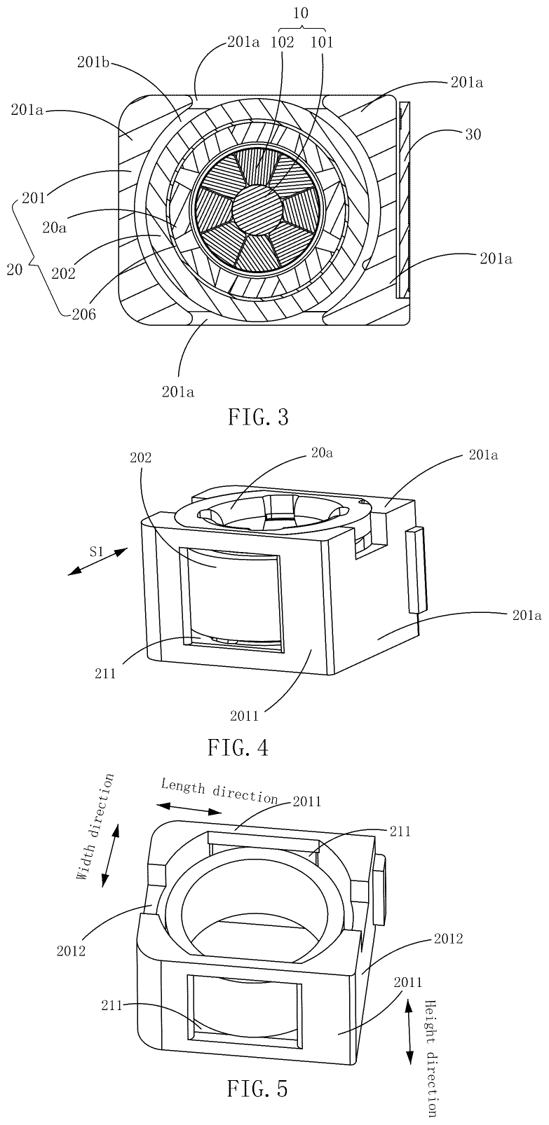

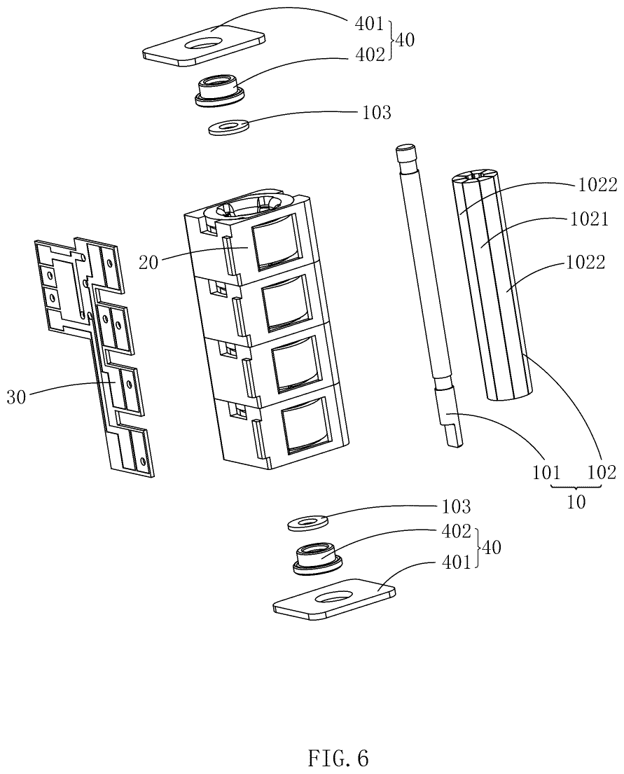

Referring to FIGS. 3 and 6, the rotor assembly 10 includes a rotary shaft 101 and a steel magnet 102. The steel magnet 102 is sleeved to an outer side of the rotary shaft 101, and is rotatable integrally with the rotary shaft 101. The steel magnet 102 may have a cylindrical shape.

FIG. 1 and FIGS. 6 to 8 illustrate an example in which a plurality of stator assemblies 20 are provided. Four stator assemblies 20 are arranged to be stacked in an axial direction of the rotor assembly 10, and each stator assembly 20 is sleeved to and spaced apart from an outer side of the rotor assembly 10. Specifically, the stator assembly 20 is sleeved to and spaced apart from an outer side of the steel magnet 102. The stator assembly 20 includes a housing 201, a coil 202, and a fixation claw pole 20a. The fixation claw pole 20a is disposed around an outer periphery of the rotor assembly 10, the coil 202 is sleeved to and fixed to the fixation claw pole 20a, and the housing 201 is sleeved to an outer periphery of the coil 202.

As shown in FIGS. 3, 4, and 5, the housing 201 includes a plurality of housing walls 201a sequentially connected in a circumferential direction of the coil 202. The plurality of housing walls 201a includes at least one first housing wall 2011. The first housing wall 2011 has a planar outer wall, and is formed with a hollowed out portion 211 configured to avoid the coil 202. A portion of the coil 202 is received in the hollowed out portion 211.

The plurality of housing walls 201a are enclosed to form a receiving cavity 201b, inner walls of the plurality of housing walls 201a are sequentially connected to form an inner wall of the receiving cavity 201b, and a shape of the inner wall of the receiving cavity 201b matches a shape of an outer wall of the coil 202.

In this embodiment, the plurality of housing walls are provided to include at least one first housing wall so that since the first housing wall is formed with a hollowed out portion to avoid the coil and a portion of the coil is received in the hollowed out portion, the size of the stepper motor in a direction S1 perpendicular to an outer wall of the first housing wall may not include a thickness of the first housing wall, and thus the size of the stepper motor in the direction S1 perpendicular to the outer wall of the first housing wall is reduced, which is conducive to realizing the miniaturization of the stepper motor. In addition, since the outer wall of the first housing wall is planar, when the stepper motor is assembled, the planar side is easy to mate with other parts, which is conducive to reducing the assembling difficulty of the stepper motor.

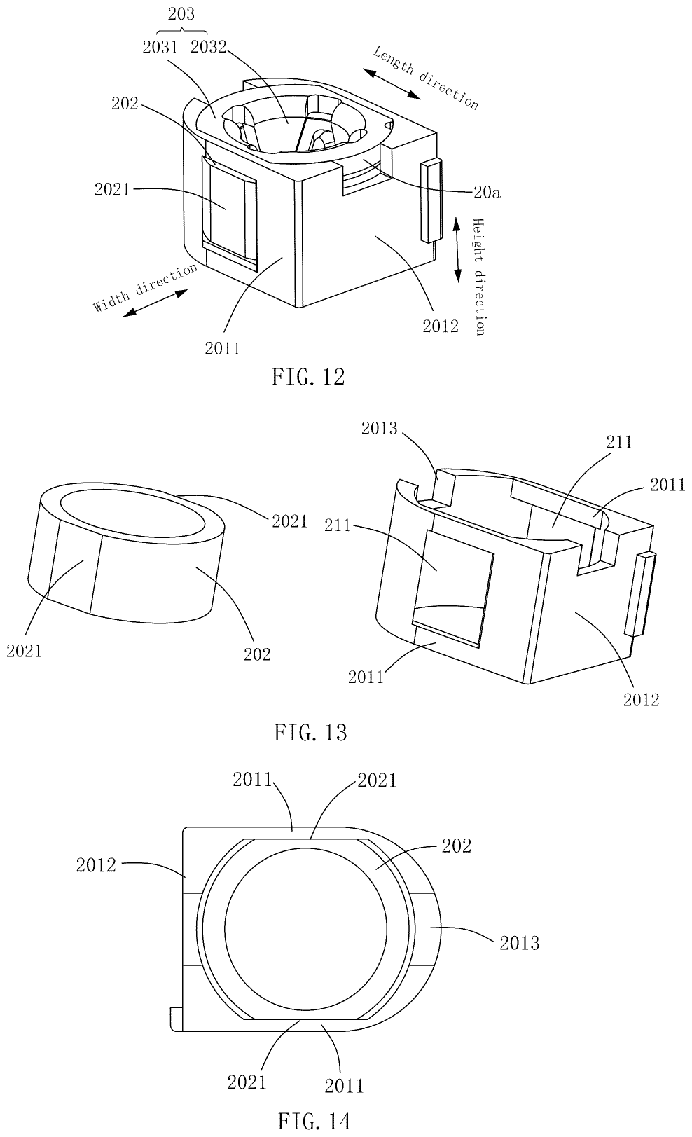

In an embodiment, as shown in FIGS. 12 to 14, a portion of the coil 202 received in the hollowed out portion 211 is formed with a first plane 2021 parallel to the outer wall of the first housing wall 2011, and the first plane 2021 is disposed on the outer wall of the coil 202. In this embodiment, an outer wall of the portion of the coil disposed within the hollowed out portion is machined to be planar, and compared with the curved surface before machining, the size of the stepper motor in the direction S1 perpendicular to the outer wall of the first housing wall is further reduced, which facilitates miniaturization of the stepper motor; alternatively, the space saved can be used to increase the number of turns of the coil, or to increase the thickness of the claw pole, or to increase the size of the steel magnet, so as to further improve the torque performance.

In an embodiment, the plurality of housing walls 201a include two first housing walls 2011 disposed opposite to each other, as shown in FIGS. 10 to 14. In this embodiment, two opposite first housing walls are provided in the same direction, and the size of the first housing wall in the direction S1 perpendicular to the outer wall of the first housing wall may not include thicknesses of the two first housing walls, which is conducive to further miniaturization of the stepper motor.

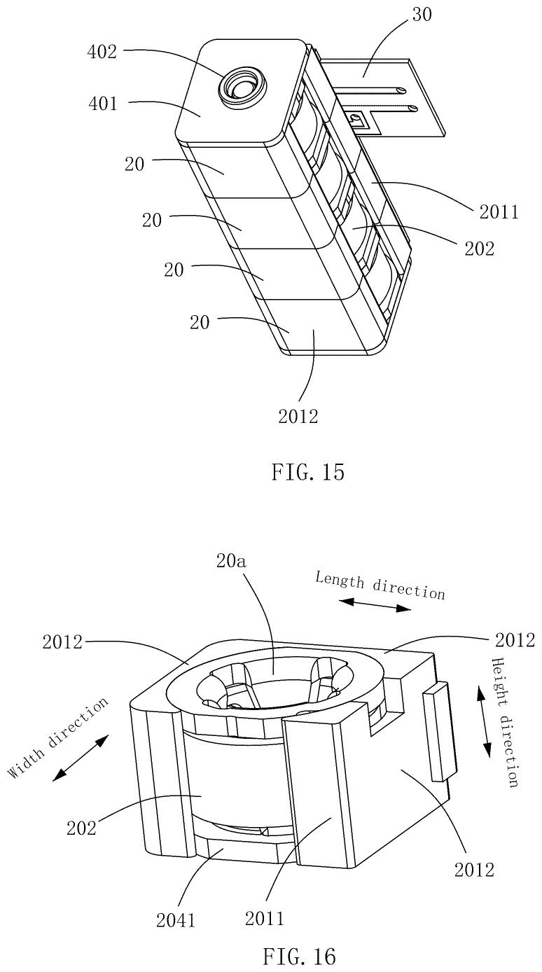

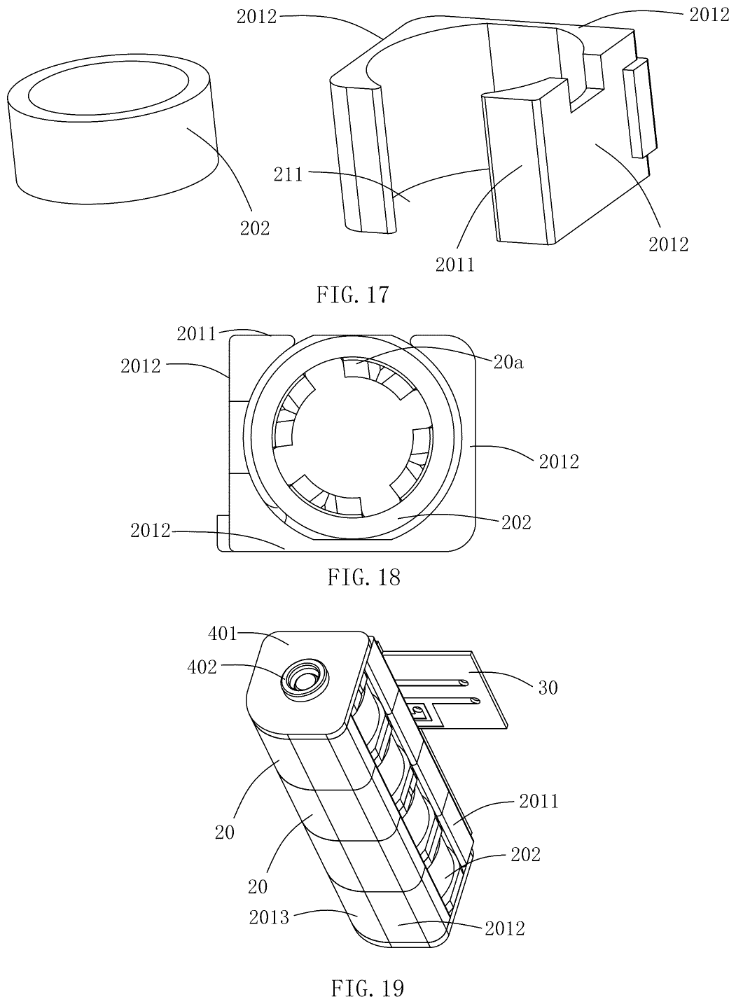

In an embodiment, referring to FIGS. 15 to 18 and FIGS. 19 to 22, the plurality of housing walls 201a include at least one second housing wall 2012, each of the at least one second housing wall 2012 having a planar outer wall. The second housing wall 2012 is not provided with a hollowed out portion, and an inner wall of the second housing wall 2012 may be curved or in another shape to match the shape of the outer wall of the coil 202. In this embodiment, the second housing wall having a planar outer wall facilitates the attachment of other electronic devices to the stepper motor without the need to provide another support structures or connection structures, which is conducive to further miniaturization of the stepper motor.

In some embodiments, referring to FIGS. 15 and 19, the stepper motor further includes a circuit board 30, and the circuit board 30 may be fixed to any of the at least one second housing wall 2012. In these embodiments, the circuit board 30 is more easily attached to the second housing wall having the planar outer wall, and can be fixed without pins, which is conducive to further miniaturization of the stepper motor. Exemplarily, in these embodiments, the lead-out of the coil 202 may be implemented by spot-welding a lead to the circuit board, and the lead-out of the circuit board is implemented without cutting the second housing wall, so as to improve the structural strength of the stepper motor.

In an embodiment, referring to FIGS. 19 to 22 and FIGS. 23 to 24, the plurality of housing walls 201a include at least one third housing wall 2013. An outer wall of the third housing wall 2013 is a curved surface, and a cross-section of the outer wall of the third housing wall 2013 is in a curved shape projecting in a direction away from the rotary shaft 101. In this embodiment, the third housing wall having a curved outer wall is provided for application scenarios where a curved surface needs to be used for fit.

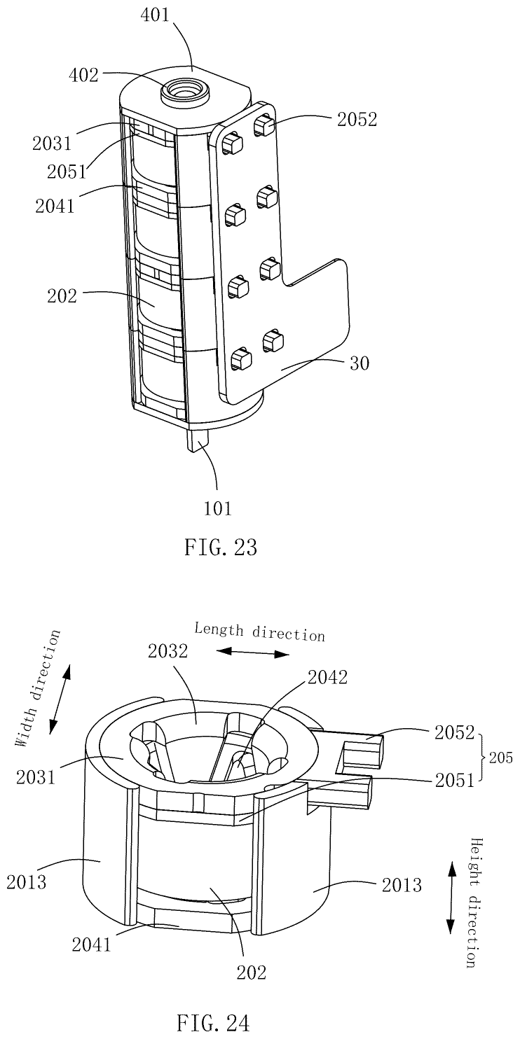

In some embodiments, as shown in FIGS. 23 to 26, the stepper motor may further include a circuit board 30, and the circuit board 30 may be disposed opposite to any of the at least one third housing wall 2013. The stator assembly 20 may further include a support foot assembly 205. The support foot assembly 205 includes a support skeleton 2051 stacked on the coil 202 in the axial direction of the rotor assembly 10, and a support foot 2052 extending from the support skeleton 2051 in a direction away from the rotary shaft 101. The third housing wall 2013 disposed opposite to the circuit board 30 is provided with an avoidance hole 212, and the support foot 2052 extends out of the housing 201 via the avoidance hole 212 and is fixedly connected to the circuit board 30. In these embodiments, the circuit board is disposed opposite to any of the at least one third housing wall, which is adaptable to the lead-out manner of the circuit board in the existing art, enhancing the versatility of the stepper motor of the present disclosure.

In some embodiments, referring to FIGS. 23 to 25, the first housing wall 2011 is fully hollowed out, with the hollowed out portion 211 extending along the entire first housing wall 2011.

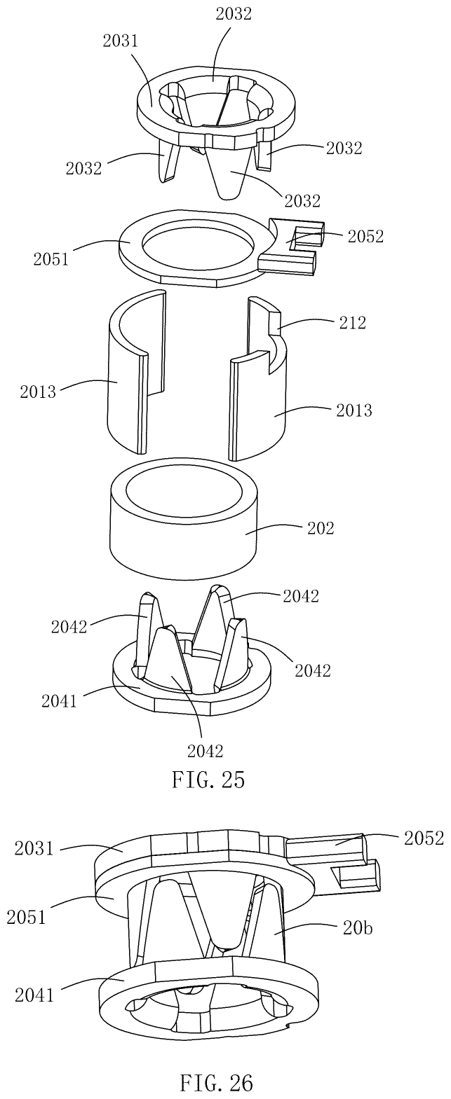

In some embodiments, referring to FIGS. 24 and 25, the housing 201 includes four housing walls 201a. The four housing walls 201a include two first housing walls 2011 (hollowed out portions 211) disposed opposite to each other; and two third housing walls 2013 disposed opposite to each other.

In an embodiment, the housing 201 has a rectangular cross-section, and includes four housing walls 201a. The four housing walls 201a may include a first number of first housing walls and a second number of second housing walls, where the first number is n1, the second number is n2, n1 and n2 are natural numbers, and a sum of n1 and n2 is 4. In this embodiment, the cross-section of the housing 201 is provided as a rectangle, which is conductive to realizing the flattening of the stepper motor to reduce the size.

In some embodiments, referring to FIGS. 3 to 5, the four housing walls 201a include two first housing walls 2011 disposed opposite to each other in a width direction of the stepper motor, and two second housing walls 2012 disposed opposite to each other in a length direction of the stepper motor. A height direction of the stepper motor is the axial direction of the rotary shaft 101. In these embodiments, the width of the stepper motor is a diameter of the coil 202, which is conducive to miniaturization of the product, and each of the two second housing walls in the length direction is not provided with a hollowed out portion, which is conducive to increasing the structural strength of the product.

In some embodiments, referring to FIGS. 16 to 18, the four housing walls 201a include one first housing wall 2011 and three second housing walls 2012. The first housing wall 2011 and one of the three second housing walls 2012 are disposed opposite to each other in the width direction of the stepper motor, and the other two second housing walls 2012 are disposed opposite to each other in the length direction of the stepper motor. The height direction of the stepper motor is the axial direction of the rotary shaft 101. In these embodiments, the first housing wall is provided in the width direction, which is conductive to reducing the size in the width direction to miniaturize the product, and all the two second housing walls in the length direction and the one second housing wall in the width direction are not provided with a hollowed out portion, which is conductive to increasing the structural strength of the product.

In an embodiment, the housing 201 includes four housing walls 201a, and the four housing walls 201a may include m1 first housing walls, m2 second housing walls, and m3 third housing walls, where m1, m2, and m3 are natural numbers, and a sum of m1, m2 and m3 is 4.

In some embodiments, the housing 201 includes, in sequence in the circumferential direction of the coil 202, a first housing wall 2011, a first of second housing walls 2012 that is connected to the first housing wall 2011, a second of the second housing walls 2012 that is connected to the first of the second housing walls 2012, and a third housing wall 2013 that is connected to the second of the second housing walls 2012 and the first housing wall 2011.

In some embodiments, the housing 201 includes, in sequence in the circumferential direction of the coil 202, a first housing wall 2011, a first of second housing walls 2012 that is connected to the first housing wall 2011, a third housing wall 2013 that is connected to the first of second housing walls 2012, and a second of the second housing walls 2012 that is connected to the first housing wall 2011 and the third housing wall 2013. The two second housing walls 2012 are disposed opposite to each other, and the first housing wall 2011 and the third housing wall 2013 are disposed opposite to each other.

In some embodiments, referring to FIGS. 12 to 14, the housing 201 includes, in sequence in the circumferential direction of the coil 202, a first of first housing walls 2011, a second housing wall 2012 connected to the first of first housing walls 2011, a second of the first housing walls 2011 that is connected to the second housing wall 2012, and a third housing wall 2013 connected to the two first housing walls 2011. The two first housing walls 2011 are disposed opposite to each other, and the second housing wall 2012 and the third housing wall 2013 are disposed opposite to each other.

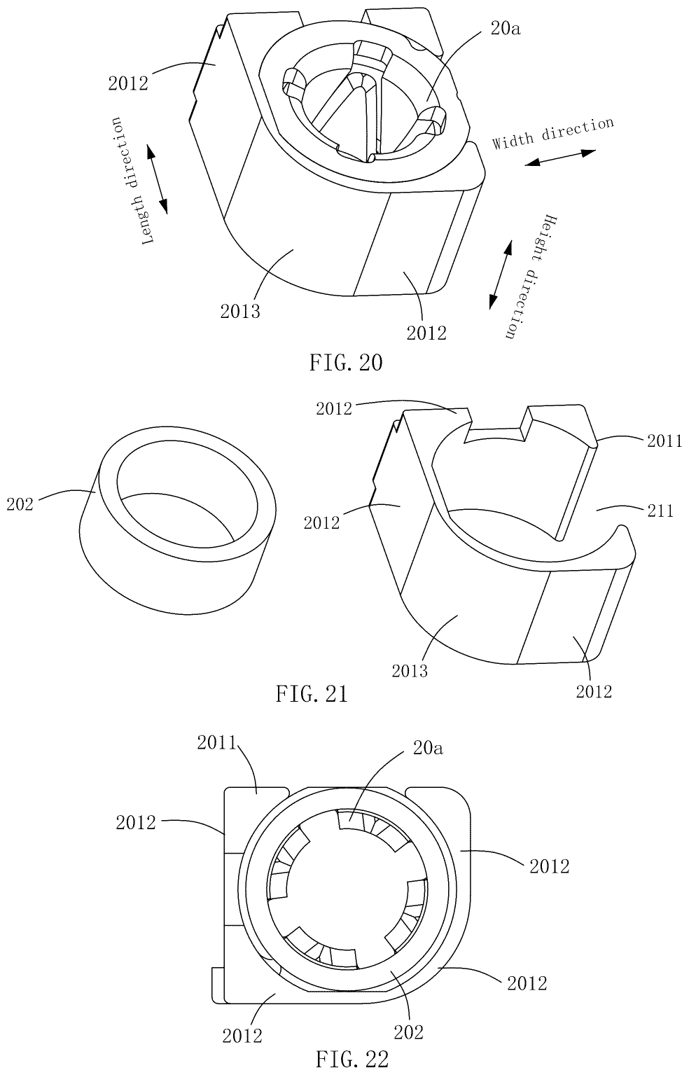

In some embodiments, referring to FIGS. 20 to 22, the housing 201 includes five housing walls 201a. The five housing walls 201a includes, in sequence in the circumferential direction of the coil 202, a first housing wall 2011, a first of second housing walls 2012 that is connected to the first housing wall 2011, a second of the second housing walls 2012 that is connected to the first of second housing walls 2012, a third housing wall 2013 connected to the second of the second housing walls 2012, and a third of the second housing walls 2012 that is connected to the third housing wall 2013 and the first housing wall 2011. The first housing wall 2011 and the second of the second housing walls 2012 are disposed opposite to each other, and the first of the second housing walls 2012 and the third of the second housing walls 2012 are disposed opposite to each other.

In an embodiment, referring to FIGS. 7 to 9, the fixation claw pole 20a includes a first claw pole portion 203 and a second claw pole portion 204 that are disposed opposite to each other and mate with each other. The first claw pole portion 203 includes a first base 2031 sleeved to the rotary shaft 101, and first claw poles 2032 bending and extending from an edge of the first base 2031 in the axial direction of the rotary shaft 101 toward the second claw pole portion 204. The first claw poles 2032 are spaced apart from each other in a circumferential direction of the first base 2031. The second claw pole portion 204 includes a second base 2041 sleeved to the rotary shaft 101, and second claw poles 2042 bending and extending from an edge of the second base 2041 in the axial direction of the rotary shaft 101 toward the first claw pole portion 203. The second claw poles 2042 are spaced apart from each other in a circumferential direction of the second base 2041. The first claw poles 2032 and the second claw poles 2042 extend in a staggered manner, where each first claw pole 2032 is located between respective two adjacent second claw poles 2042. The first claw poles 2032 and the second claw poles 2042 enclose a claw pole ring 20b, and the coil 202 is sleeved to the claw pole ring 20b.

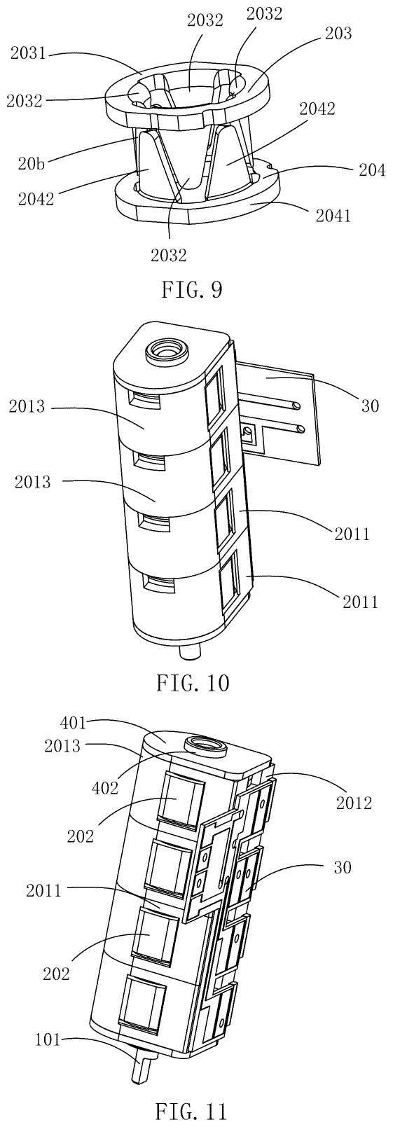

In some embodiments, referring to FIGS. 9 and 26, a plurality of first claw poles 2032 are evenly spaced around an inner periphery of the first base 2031, and a plurality of second claw poles 2042 are evenly spaced around an inner periphery of the second base 2041. When the coil 202 is sleeved to the claw pole ring 20b, the coil 202 is disposed between the first base 2031 and the second base 2041; and when the housing 201 is sleeved to the coil 202, both an outer periphery of the first base 2031 and an outer periphery of the second base 2041 abut an inner wall of the housing 201.

In some embodiments, referring to FIG. 6, a plurality of first magnetic poles 1021 and a plurality of second magnetic poles 1022 are formed on an outer surface of the steel magnet 102 and arranged in a staggered manner in a circumferential direction of the steel magnet 102, where the first magnetic poles 1021 and the second magnetic poles 1022 have magnetically opposite polarities. For example, the first magnetic poles 1021 are N-poles, and the second magnetic poles 1022 are S-poles; alternatively, the first magnetic poles 1021 are S-poles, and the second magnetic poles 1022 are N-poles.

In some embodiments, referring to FIG. 9, when the first claw pole portion 203 and the second claw pole portion 204 mate with each other, the plurality of first claw poles 2032 of the first claw pole portion 203 and the plurality of second claw poles 2042 of the second claw pole portion 204 are provided interspersed with each other, i.e., each second claw pole 2042 is located in a spacing area between respective two adjacent first claw poles 2032, and the first claw poles 2032 and the second claw poles 2042 are provided corresponding to the first magnetic poles 1021 or the second magnetic poles 1022 of the steel magnet. For the same stator assembly 20, the first magnetic poles 1021 and the second magnetic poles 1022 have magnetically opposite polarities. For example, the first magnetic poles 1021 are N-poles, and the second magnetic poles 1022 are S-poles; alternatively, the first magnetic poles 1021 are S-poles, and the second magnetic poles 1022 are N-poles. Further, the first claw poles 2032 are evenly spaced, the second claw pole 2042 are evenly spaced, and widths of the first claw poles 2032 and the second claw poles 2042 gradually decrease along their respective extension directions.

In some embodiments, referring FIGS. 3, 7, and 8, a cylindrical adhesive layer 206 is further provided between the claw pole ring 20b and the coil 202.

Referring back to FIGS. 3, 7 to 8, the stepper motor further includes support assemblies 40. Two support assemblies 40 are disposed at two end of the rotor assembly 10 respectively, as shown in FIGS. 3, 4 and 5. Each support assembly 40 includes an end cover 401 and a bearing 402. The end cover 401 is connected to the rotary shaft 101 via the bearing 402, and the rotary shaft 101 is rotatable relative to the end cover 401.

Further, gaskets 103 are provided at the top and the bottom of the steel magnet 102 respectively. Each gasket 103 is annular, sleeved to the rotary shaft 101, and located between the steel magnet 102 and the bearing 402.

The above are only embodiments of the present disclosure, and it should be noted that for a person of ordinary skill in the art, improvements may be made without departing from the concept of the present disclosure, all of which fall within the scope of protection of the present disclosure.

What is claimed is:

1. A stepper motor, comprising:
a rotor assembly, including a rotary shaft, and a steel magnet sleeved to an outer side of the rotary shaft; and
a stator assembly, sleeved to an outer side of the rotor assembly and including a fixation claw pole disposed around an outer periphery of the rotor assembly, a coil sleeved to an outer side of the fixation claw pole, and a housing sleeved to the coil;
wherein the housing includes a plurality of housing walls sequentially connected in a circumferential direction of the coil, the plurality of housing walls include at least one first housing wall, each respective first housing wall of the at least one first housing wall has a planar outer wall and is formed with a hollowed out portion configured to avoid the coil, and a portion of the coil is received in the hollowed out portion.

2. The stepper motor according to claim 1, wherein the portion of the coil received in the hollowed out portion is formed with a first plane parallel to the outer wall of the respective first housing wall.

3. The stepper motor according to claim 1, wherein the plurality of housing walls include two first housing walls disposed opposite to each other.

4. The stepper motor according to claim 1, wherein the plurality of housing walls further include at least one second housing wall, each of the at least one second housing wall having a planar outer wall.

5. The stepper motor according to claim 4, wherein the stepper motor further includes a circuit board fixed to an outer side of the housing, the circuit board being fixed to any one of the at least one second housing wall.

6. The stepper motor according to claim 1, wherein the plurality of housing walls further include at least one third housing wall, each of the at least one third housing wall having a curved outer wall.

7. The stepper motor according to claim 6, wherein the stepper motor further includes a circuit board fixed to an outer side of the housing, the circuit board being disposed opposite to any one of the at least one third housing wall; and
wherein the stator assembly further includes a support foot assembly, and the support foot assembly includes a support skeleton stacked on the coil in an axial direction of the rotor assembly, and a support foot extending from the support skeleton in a direction away from the rotary shaft; and
wherein the any one of the at least one third housing wall disposed opposite to the circuit board is provided with an avoidance hole, and the support foot extends out of the housing via the avoidance hole and is fixedly connected to the circuit board.

8. The stepper motor according to claim 4, wherein the housing has a rectangular cross-section and includes four housing walls, wherein the four housing walls may include a first number of first housing walls and a second number of second housing walls, a sum of the first number and the second number is 4, and the first number and the second number are natural numbers.

9. The stepper motor according to claim 4, wherein the plurality of housing walls further include at least one third housing wall, each of the at least one third housing wall having a curved outer wall.

10. The stepper motor according to claim 6, wherein the housing includes four housing walls, and the four housing walls include two first housing walls disposed opposite to each other, and two third housing walls disposed opposite to each other.

11. The stepper motor according to claim 1, wherein the stepper motor includes a plurality of stator assemblies and a plurality of housings sleeved to the plurality of the stator assemblies respectively, the plurality of the stator assemblies being sequentially stacked in an axial direction of the rotor assembly, and the plurality of housings being sequentially stacked along the axial direction of the rotor assembly;
wherein the fixation claw pole includes a first claw pole portion and a second claw pole portion disposed opposite to each other and mating with each other;
wherein the first claw pole portion includes a first base sleeved to the rotary shaft, and first claw poles bending and extending from an edge of the first base in the axial direction of the rotary shaft toward the second claw pole portion, the first claw poles being spaced apart from each other in a circumferential direction of the first base;
wherein the second claw pole portion includes a second base sleeved to the rotary shaft, and second claw poles bending and extending from an edge of the second base in a circumferential direction of the rotary shaft toward the first claw pole portion; and
wherein the first claw poles and the second claw poles extend in a staggered manner, each of the first claw poles is located between respective two adjacent second claw poles of the second claw poles, the first claw poles and the second claw poles enclose a claw pole ring, and the coil is sleeved to the claw pole ring.
